(19) United States
(12) Patent Application Publication
(10) Pub. No.: US 2025/0015506 A1
(43) Pub. Date: Jan. 9, 2025

(54) METAMATERIAL-BASED COMPACT ANTENNA-IN-PACKAGE SOLUTIONS IN FREQUENCY HANDOVER APPLICATIONS

(71) Applicant: University of Florida Research Foundation, Inc., Gainesville, FL (US)

(72) Inventors: Yong Kyu Yoon, Gainesville, FL (US); Payman Pahlavan, Gainesville, FL (US); Hae-In Kim, Gainesville, FL (US); Suk-il Choi, Gainesville, FL (US); Hanna Jang, Gainesville, FL (US); Alexander Wilcher, Gainesville, FL (US)

(21) Appl. No.: 18/747,334

(22) Filed: Jun. 18, 2024

Related U.S. Application Data
(60) Provisional application No. 63/512,533, filed on Jul. 7, 2023.

(51) Int. Cl. H01Q 15/00; H01Q 5/392; H01Q 21/06

(52) U.S. Cl. CPC H01Q 15/0086; H01Q 5/392; H01Q 21/065

(57) ABSTRACT

The present disclosure describes dual-band antenna arrays and related methods for manufacturing and implementing dual-band antenna arrays. One exemplary dual-band antenna array comprises a top layer of fused silica substrate; a bottom layer of fused silica substrate; a ground plane positioned between the top and bottom layers of fused silica substrate, wherein the ground plane comprises layers of three different metals; antenna patch elements arranged on top of the top layer of fused silica substrate; an input feedline arrange on the bottom layer of the fused silica substrate; and a meanderline complimentary split ring resonator structure etched on a top surface of the ground plane, wherein the input feedline is directly coupled to the meanderline complimentary split ring resonator structure and is configured to excite a plurality of resonance frequencies of the antenna patch elements.

### CROSS-REFERENCE TO RELATED APPLICATION

This application claims priority to co-pending U.S. provisional application entitled, “Metamaterial-Based Compact Antenna-In-Package Solutions in Frequency Handover Applications,” having Ser. No. 63/512,533, filed Jul. 7, 2023, which is entirely incorporated herein by reference.

### STATEMENT REGARDING FEDERALLY SPONSORED RESEARCH OR DEVELOPMENT

This invention was made with government support under 2030122 awarded by the National Science Foundation. The government has certain rights in the invention.

### BACKGROUND

With the emerging commercial application of the 5G-NR Frequency Range 2 (FR2) band in the millimeter wave 28 GHz band and Internet-of-Things (IoT) applications in the submillimeter 24 GHz band, the need for multiband, compact, and low loss passive elements for wireless communication has been raised. Maximizing bandwidth efficiency by using frequency handover techniques requires wideband and multiband hardwares with minimum ohmic loss, which in turn increases the demand for heterogeneous integrations and three-dimensional (3D) packaging to eliminate or reduce unwanted and intolerable power loss that occurs in conventional two-dimensional transceiver structures and to minimize devices' footprints. Especially in the millimeter region, in which the dimensions of passive elements such as antennas are comparable to those of transceiver chips, efforts have been made to integrate them with the radio frequency (RF) front-end monolith microwave integrated circuits (MMICs) for more than a decade. Although the antenna-on-chip (AoC) solution provides very compact 3D solutions and omits the need for parasitic interconnects, the silicon itself degrades the antenna's performance due to its dielectric loss.

Therefore, antenna in package (AiP) solutions were introduced to alleviate the AoC drawbacks. AiP first gained the most interest in 60 GHz applications. In this configuration, the antenna is designed on a substrate that itself carries the MMIC chips. The MMIC may be bonded to the substrate or attached by embedding solutions. Multiple layers of substrate with different properties are stacked on top of each other to provide a three-dimensional integration of passive and active elements. Organic and ceramic materials are the most widely used materials as substrates. However, each of these materials has some nonnegligible drawbacks concerning path loss, moisture absorption, warpage, scalability, design precision, and cost.

More importantly, at mmWave frequencies, the conductor surface roughness plays an important role in total power dissipation. The Root Mean Square (RMS) surface roughness of commercially available technologies such as printed circuit boards (PCB), epoxy mold compounds, and ceramics are above hundreds of nanometers. Studies show that for frequencies above 20 GHz, such rough surfaces will increase signal power dissipation significantly. Hence, together with the dielectric factor, the surface quality plays a crucial role in signal and power integrity in high frequencies.

Recently, glass-based substrates have been introduced to AiP solutions. Substrates like fused silica and borosilicate glass exhibit not only a very low dielectric loss, but they also possess a very smooth surface on the order of a few nanometers. This factor is in the order of micrometers in other materials such as polyamides and epoxy molds. Glass also has some other useful properties. The dielectric constant of the glass can be tailored and customized for different applications. Its coefficient of thermal expansion matches that of silicon which is necessary for IC embedding and guarantees secure interconnects in a wider temperature range. It can be used in both large and low-cost panels. And finally, very fine pitches, lines, vias, and spaces can be designed on glass substrates by photolithography methods. Metal widths and spaces as low as 2 um are achieved on glass substrates using advanced semi-additive processing methods.

However, the efficiency of a passive circuit is not only limited to the ohmic loss; it can also be affected by crosstalks and unwanted mutual couplings between various elements of an integrated passive circuit. The issue can be particularly problematic in antenna array designs in which the distance or pitch between antenna elements plays the main role in minimizing the crosstalks and the resulting power loss. The arrangement of multiple antennas in array configurations is a well-established approach to enhance antenna gain, directivity of the antenna, and provide beam shaping capability by providing a specific phase difference between subarray elements. However, the array pitch between antennas needs to be carefully selected since the mutual couplings between the antenna elements can degrade the radiation pattern and the total gain. If there is not enough decoupling between the antennas, a portion of the applied power to any antenna element will be absorbed by adjacent antennas instead of radiating. For example, in a two-dimensional patch array, the pitch is selected to be at least 0.5λ₀ to secure a desired mutual decoupling. This restriction makes antenna arrays very large compared to the MMIC circuits.

The large pitch will also increase the number and amplitude of side lobes in the array pattern. Sine for a given N×M antenna array, the array factor is defined as

$$AF ( θ , φ ) = \{ \frac{sin ( \frac{N}{2} {Ψ}_{x} )}{N sin ( \frac{{Ψ}_{x}}{2} )} \} \{ \frac{sin ( \frac{N}{2} {Ψ}_{y} )}{M sin ( \frac{{Ψ}_{y}}{2} )} \}$$

$${ψ}_{x} = \frac{2 π}{λ} d sin θcosφ ,$$

$${ψ}_{y} \frac{2 π}{- λ} d sin θsinφ$$

where d is a center-to-center distance between two antennas in an array and θ and φ are the azimuth and elevation angles of the receiving object in the spherical coordinates. And, the total array pattern is a product of a single antenna pattern and the array factor. Hence, there is a trade-off between radiation efficiency and radiation pattern quality. Due to the need to reduce the array size and fit it in small areas, mutual decoupling structures are typically introduced between antenna elements.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1(a)-1(e) illustrate the three-dimensional concept of an exemplary compact dual-band antenna array with FIG. 1(a) showing an oblique view of a 2×2 patch array on a dual layer Fused-silica substrate; FIG. 1(b) showing a layer stack up view; FIG. 1(c) showing a meanderline complimentary split ring resonator (CSRR) structure; FIG. 1(d) showing a bottom view of the single band aperture fed 2×2 array with ports and meanderlines; and FIG. 1(e) showing a bottom view of the exemplary dual-band CSRR fed 2×2 array with the asymmetric power splitter designed for fabrication, in accordance with various embodiments of the present disclosure.

FIG. 2 is a graph showing the effect of array pitch and the existence of meanderlines on the return loss and mutual couplings of the 2×2 patch array of FIG. 1(a).

FIG. 3 is a graph showing the effect of array pitch and the existence of meanderlines on the radiation pattern of the 2×2 patch array of FIG. 1(a).

FIG. 4(a) depicts coupled resonance phenomenon occurring in a compact 2×2 patch array involving resonant frequencies appearing among patch elements, in accordance with the present disclosure.

FIG. 4(b) depicts coupled resonance phenomenon occurring in a compact 2×2 patch array involving resonant frequencies appearing among CSRRs, in accordance with the present disclosure.

FIG. 4(c) is a graph showing simulated return losses at multiple resonant frequencies of a patch inside a compact 2×2 CSRR fed array, in accordance with various embodiments of the present disclosure.

FIG. 4(d) shows a novel feeding CSRR technique with CSRRs being excited directly by a microstrip line attached to an open stub, in accordance with various embodiments of the present disclosure.

FIG. 4(e) is a graph showing simulated return losses of a patch inside a compact 2×2 CSRR-fed compact 2×2 array having a dual band response at 24 GHz and 28 GHz, in accordance with various embodiments of the present disclosure.

FIG. 5 shows a scalable size reduction in antenna arrays based on CSRR feeding and decoupling in a 2×2 compact dual band array, in accordance with various embodiments of the present disclosure.

FIGS. 6(a)-6(b) show two possible phase distribution for broadside radiation pattern for a compact dual band 2×2 array with FIG. 6(a) being directed to a linear radiation pattern with 180° phase steps and FIG. 6(b) being directed to a circular radiation pattern with 90° phase steps.

FIG. 6(c) provides a table (Table 1) showing Finite Element Method (FEM) derived gain and efficiency comparison between a conventional aperture-fed antenna array versus an exemplary CSRR-fed antenna array for 2×2 and 4×4 array sizes, in accordance with various embodiments of the present disclosure.

FIGS. 7(a)-7(h) show an exemplary fabrication process for an exemplary CSRR-fed antenna array in accordance with various embodiments of the present disclosure.

FIGS. 8(a)-8(c) are photographic images of fabricated 2×2 and 4×4 antenna arrays with (a) patch arrays made on a 350 μm thick wafer; (b) feedlines made on a 180 μm thick wafer; and (c) a CSRR inside its window made on the ground plane between the two wafers, in accordance with various embodiments of the present disclosure.

FIG. 9 is a graph showing measured and simulated return losses of a compact 2×2 CSRR fed array, in accordance with various embodiments of the present disclosure.

FIG. 10 is a graph showing measured and simulated return losses of a compact 4×4 CSRR fed array, in accordance with various embodiments of the present disclosure.

FIGS. 11(a)-11(b) show simulated three-dimensional radiation patterns of an exemplary compact dual band 4×4 CSRR fed array at (a) 24.17 GHz and (b) 28.67 GHz.

FIGS. 12(a)-12(b) show measured and simulated radiation patterns of a compact dual band 4×4 CSRR fed array at 24.17 GHz on (a) the E-plane (YZ) and (b) the H-plane (XZ), in accordance with various embodiments of the present disclosure.

FIGS. 13(a)-13(b) show measured and simulated radiation patterns of a compact dual band 4×4 CSRR fed array at 28.67 GHz on (a) the E-plane (YZ) and (b) the H-plane (XZ), in accordance with various embodiments of the present disclosure.

### DETAILED DESCRIPTION

The present disclosure describes various embodiments of systems, apparatuses, and related methods for fabricating a dual-band compact antenna array that can simultaneously work in dual frequency bands, such as the 5G-NR millimeter band (e.g., millimeter wave 28 GHz band) and 24 GHz automobile radar band (submillimeter IoT). In accordance with the present disclosure, the coupling theory of metamaterial resonators is utilized to support two commercial frequency bands with one antenna array.

Accordingly, the present disclosure examines the role of metamaterial resonators on frequency response, array size, and mutual decoupling with a mmWave antenna on a fused silica package and presents an exemplary dual-band compact antenna array having a novel complimentary split ring resonator (CSRR) feeding technique which is used to add a second frequency band to the array by leveraging the coupled resonance technique.

Mostly named as electromagnetic bandgap structures, metamaterial resonators such as split ring resonators (SRRs) and CSRRs are mainly used between antennas to act as a band stop filter in antenna resonant frequencies and block the power transmission between antennas in an array. These structures are mostly investigated between two antennas in a 2×1 patch array. Recent studies indicated the effectiveness of such an approach in a 2×2 patch array. In these studies, the antenna pitch is reduced dramatically to 0.05λ₀ for a 5 GHz symmetric diagonally fed patch array on a RF4 substrate, where the diagonal feeding is proposed to overcome the impedance variations between the antennas. Impedance variation results in different resonant frequencies for antenna elements necessitating different impedance matching for each antenna. Although these studies mainly focused on reducing the array pitch, the radiation pattern and directivity of the antenna still does not show suitable performance.

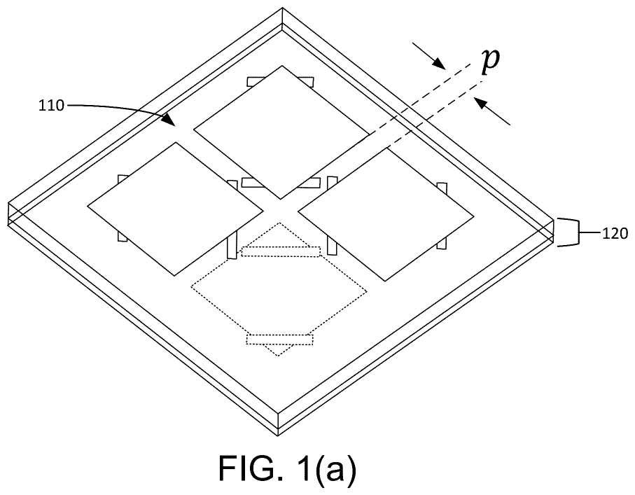

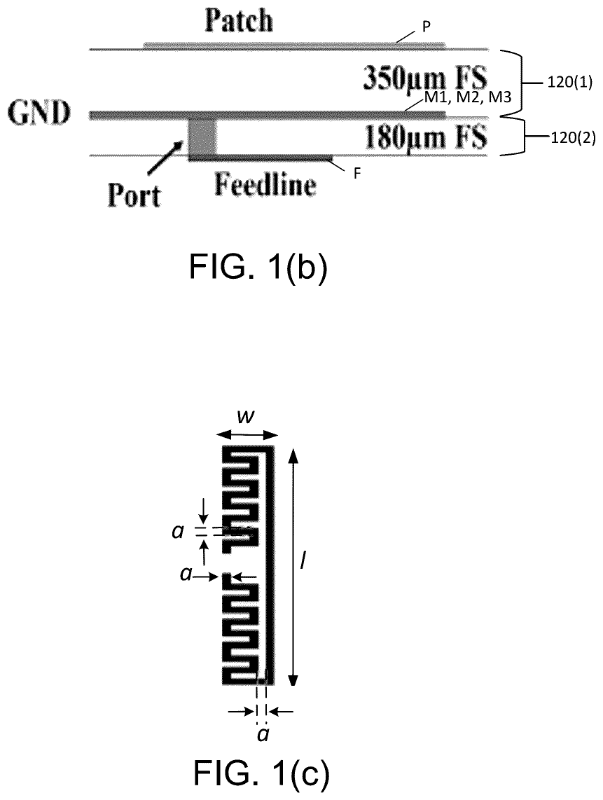

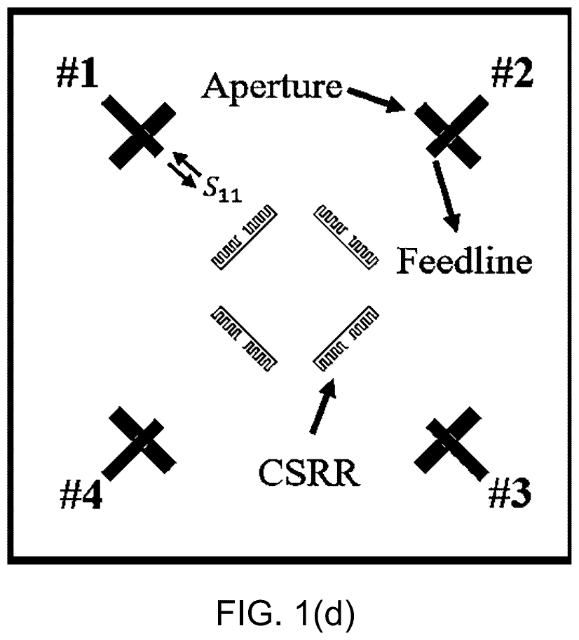

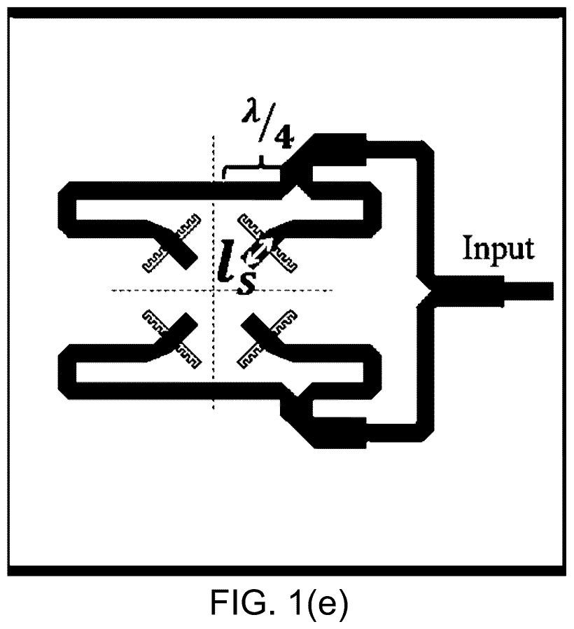

Referring now to FIGS. 1(a)-(e), these figures illustrate a three-dimensional concept of an exemplary dual-band compact antenna array working at 28 GHz. In particular, FIG. 1(a) shows an oblique view of a 2×2 patch array 110 on a dual layer fused-silica substrate 120; FIG. 1(b) shows a layer stack up view; FIG. 1(c) shows a meanderline CSRR structure; FIG. 1(d) shows a bottom view of the single band aperture fed 2×2 array with ports and meanderlines; and FIG. 1(e) shows a bottom view of the exemplary dual-band CSRR fed 2×2 array with the asymmetric power splitter designed for fabrication, in accordance with various embodiments of the present disclosure.

Correspondingly, as shown in FIG. 1(b), the design includes two fused silica layers 120(1), 120(2), and three metal layers M1, M2, M3 acting as the ground layer. Patch elements P are placed on the top side of a 350 μm thick fused silica wafer, while the feedline F is placed on the bottom side of a 180 μm thick fused silica wafer. The four patch elements are located very close to one another separated by p=0.048λ₀ with λ₀ being the free space wavelength. This compactness is only possible by providing decoupling structures. Accordingly, four meanderline CSRR resonators are etched on the ground layer to serve such purpose. In particular, to reduce the pitch p as low as possible, the four meanderline CSRRs are designed to resonate around the desired frequency and are placed diagonally on the ground plane beneath the antenna elements. A careful optimization on CSRR gap a, width w, and length l can result in p as small as 0.048λ₀ with λ₀ being the free space wavelength.

One novelty of this structure is in the implementation of metamaterials in a fused silica-metal-fused silica stack-up with an eutectic gold bonding method. As a matter of fact, the ground layer containing both apertures and meanderline resonators also acts as the bonding layer attaching the two fused silica wafers together.

Unlike ordinary patch arrays, the radiation pattern of a symmetric diagonally fed array is not directive but looks more like a dipole antenna. Placing CSRRs on the middle layer helps design a multilayer structure with the ability to add a redistribution layer to the antenna package. As illustrated in FIG. 1(a), antennas are fed diagonally to support circular polarization. In addition, the symmetry of the array around its center provides equal boundary condition for all antennas and eliminates any difference in the resonant frequency of these four elements. In fact, a 180° phase shift is needed to be applied to compensate the geometrical feeding difference caused by the symmetric feeding apertures. Hence, ports 1 and 4 are exited with 180° phase shifts compared to port 2 and 3.

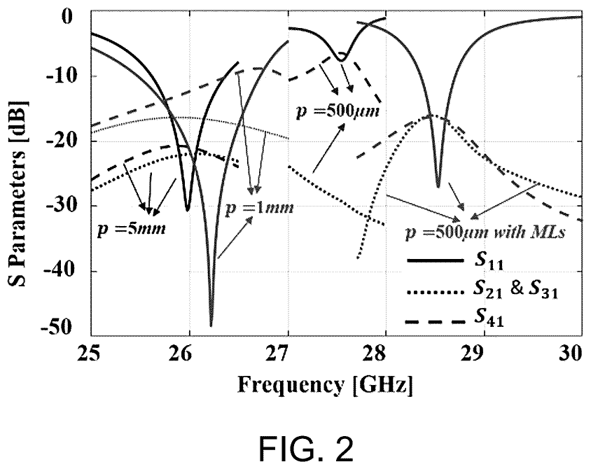

To investigate the effect of meanderlines on the array properties, full wave simulation by High Frequency Structure Simulator (HFSS) is conducted on a 2×2 patch array with different pitches and a comparison is made in FIG. 2 with and without meanderlines. As expected, reducing the pitch p from 5 mm to 0.5 mm not only shifts the resonant frequency, but it also increases the mutual couplings and reduces the resonance bandwidth. In this analysis, four lumped ports are assigned to feed the four patch elements in a 2×2 array and scattering parameters for one of the antennas are reported. The HFSS simulation shows that while the coupling between vertical and horizontal elements is below 20 dB for a simple array with p=5 mm resonating at 26 GHz, reducing p increases mutual couplings significantly so that the diagonal coupling S₃₁ for p=0.5 mm is around −5 dB while the 10 dB bandwidth is zero.

However, for p=500 μm, adding meanderlines to the ground layer between the two substrates not only improves return loss bandwidth (BW), but it also decreases mutual decouplings by 10 dB. Since there are four diagonal couplings S₁₃, S₃₁, S₂₄, and S₄₂ in each tile, this method will improve the radiation efficiency dramatically especially since the initial coupling was around −5 dB, meaning at least 25% of the delivered power to each antenna is absorbed by the other antennas and not radiated. Hence, adding the meanderlines increases the radiation efficiency from 10% to 70%.

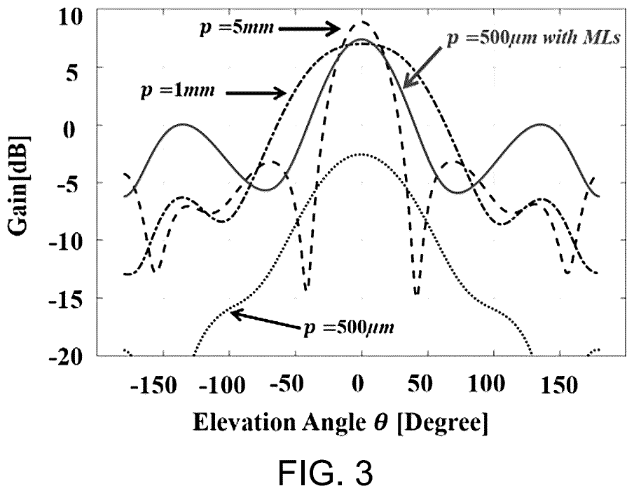

An asymmetric feeding can provide a directive radiation pattern by improving the gain by more than 10 dB. The effect of mutual couplings on the array gain is also explained in FIG. 3. Here, the simulated elevation radiation pattern shows that for a 2×2 array, the maximum gain decreases by 15 dB if p is decreased from λ₀ to 0.048λ₀. However, adding the meanderlines together with asymmetric feeding network can improve the gain by 10 dB. It should be noted that higher gains necessitate a larger p. In other words, a size-gain trade-off needs to be considered in practice.

While adding metamaterial resonators to the structure improves the mutual coupling and radiation efficiency, it fails to provide adequate improvement to the frequency bandwidth. As shown in FIG. 2, as p decreases, the BW also decreases to zero while adding meanderline resonators will increase the BW up to just 2%.

However, despite bandwidth drawbacks, closely located resonators (antennas and CSRRs) could show some beneficial properties in addition to size reduction. Reducing the distance between two or more identical resonators creates additional resonances called coupled resonance phenomenon. Based on coupled resonance theory, the resonant frequency of a resonator can be affected by adjacent identical resonators if they are coupled together. As in the example of a pair of spring connected pendulum pair, the overall resonance will be a linear combination of two different frequencies. Similarly, the coupling between two or more electromagnetic resonators, either electrically, magnetically, or both, can yield multiple resonant frequencies.

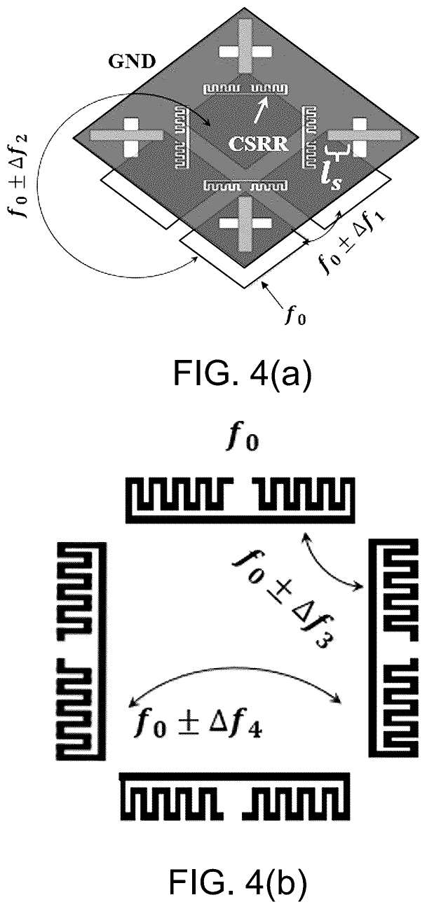

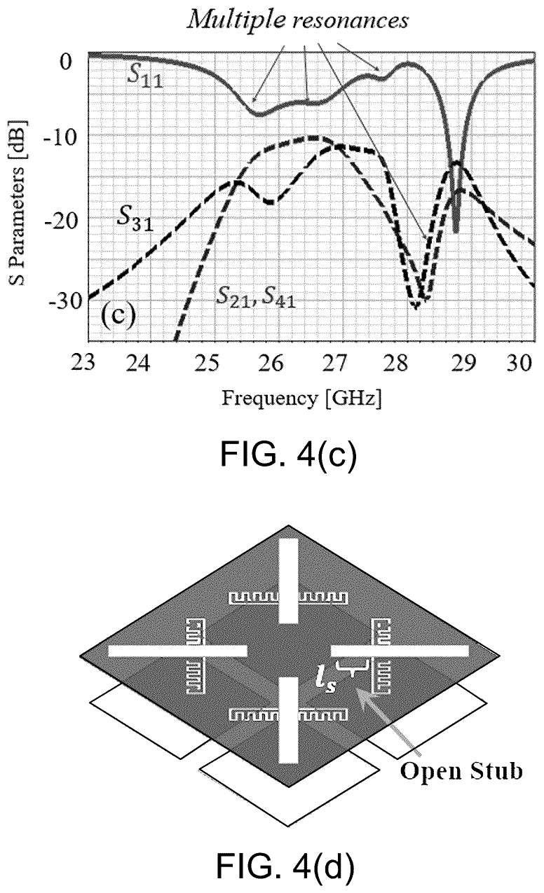

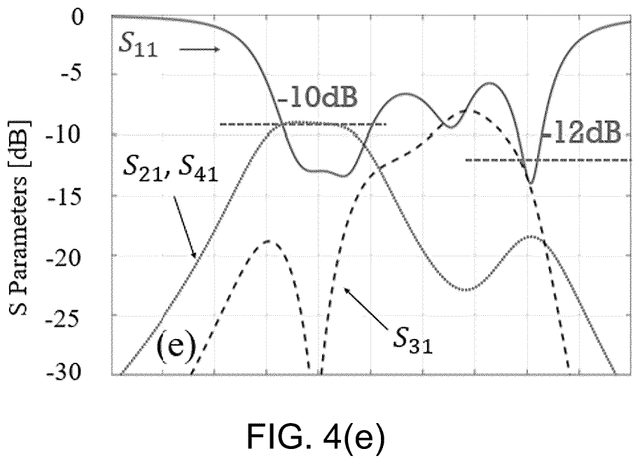

This phenomenon, which also occurs in low pitch antenna arrays as an array of identical single-band resonators, is leveraged in the present disclosure to design multiband arrays. As qualitatively described in FIGS. 4(a)-4(b), the presence of four closely spaced patches and CSRRs in such an array introduces multiple resonances. However, due to the single band nature of conventional feeding structures, such as aperture and via, the antenna input return loss occurring on these additional resonant frequencies is not sufficient for an efficient radiation and bandwidth.

In aperture fed patch, the aperture size defines the resonant frequency in aperture feeding technique and further matching is achieved through the open stub on the feedline as in FIG. 4(a). In the case of via feeding, although a via is wide band, the position of vias across the antenna area dictates the antenna impedance, rendering precise impedance matching across multiple frequencies unfeasible. This in turn necessitates complicated impedance matching for additional bands.

In addition, apertures and vias exhibit high mutual coupling at smaller pitches, while meanderline CSRRs maintain effective decoupling even at minimal separations, thanks to highly confined fields at their resonant frequencies. Thus, in the present disclosure, new methods are presented to couple feedlines to the antenna by replacing the coupling apertures with the CSRR structures which is associated with an asymmetric feedline to realize the required phase shifts between the antennas, as shown in FIG. 1(e). Like the aperture coupling approach, the feedline is open ended with an optimized stub length is to provide an impedance match at both resonance frequencies. Thus, exemplary methods can provide sufficient decoupling and support more than one operating frequency for the path array.

Full wave simulation demonstrates that the meander line CSRR is not only as effective as an aperture at exciting the antenna, but it can also couple the feedline to the antenna at multiple frequencies. As depicted in FIG. 4(d), in one new exemplary feeding technique, coupling apertures are replaced by meanderline CSRRs. A microstrip feedline ending in an open stub can excite the CSRR and the associated antenna as it does in the aperture feeding technique. Since the CSRRs are directly excited by the feedline, a proper stub length is can provide sufficient matching in more than one resonant frequency. A comparison between FIG. 4(c) and FIG. 4(e) unveils the effectiveness of this technique. While the array in FIG. 4(a) is excited through apertures and decoupled by CSRRs, it has inadequate return loss in all the resonant frequencies except for the main frequency corresponding to the aperture size. However, the CSRR fed array in FIG. 4(d) can support more frequencies shown in FIG. 4(e). With this technique, a wide band resonance is added to the array centered at 24 GHz.

This new technique can maintain the desired isolation in the main frequency at 28 GHz and provide isolation on the second frequency band as well. In this novel feeding method, there is no aperture or via to feed the antennas, and CSRRs can perform both feeding at 24 GHz and decoupling at 28 GHz. As shown in FIG. 4(e), with further tuning, two standard 1.2 cm and LMDS 5G bands can be simultaneously supported with this novel structure. While the mutual couplings stay around −15 dB for 28 GHz, it will be slightly worse for 24 GHz. However, this array also shows a resonance at 24 GHz with at least 10 dB decoupling which can be improved by further optimization. The 24 GHz band provides much wider bandwidth since it includes two close resonant frequencies.

Accordingly, careful optimizations resulted in a dual-band coupling between the antenna and the feedlines. This method not only simplifies the 2×2 compact array model by omitting apertures, but also provides a multi band impedance match for each patch. In this approach, the input feedline can be directly coupled with meanderlines and excite all resonant frequencies and depending on the radiation bandwidths of the patch antennas, some of these frequencies can provide acceptable return loss.

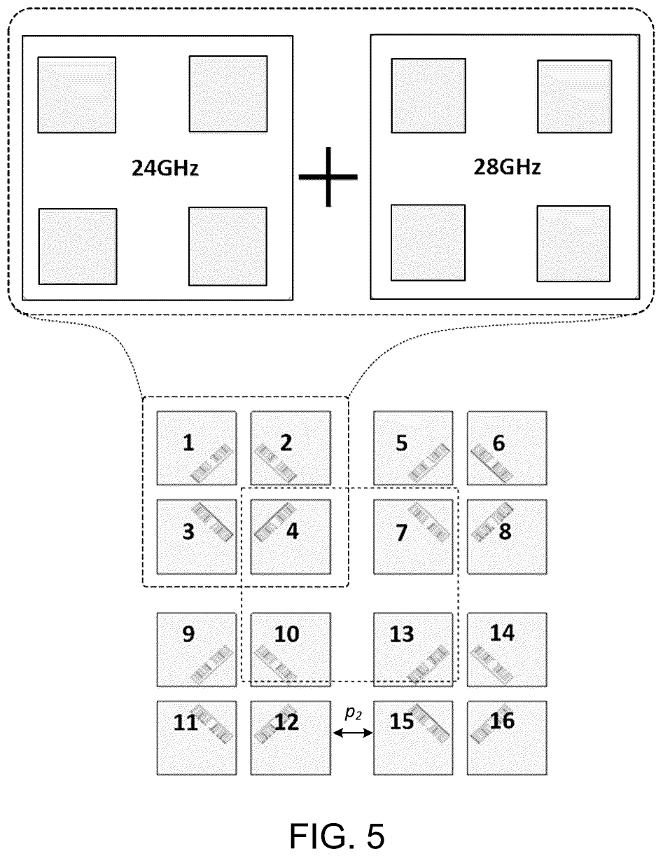

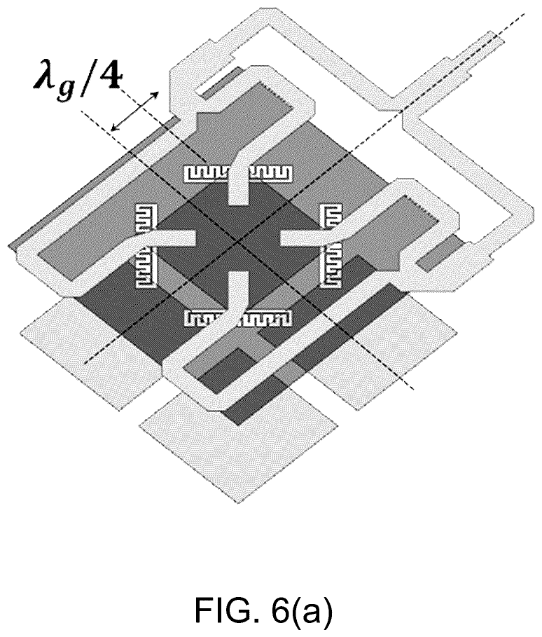

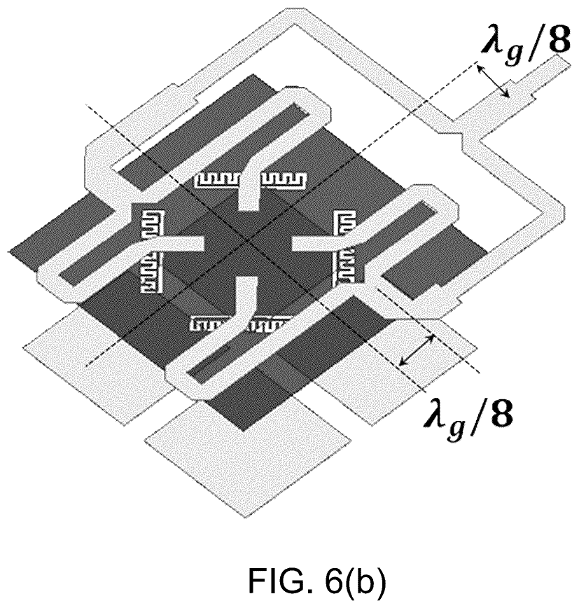

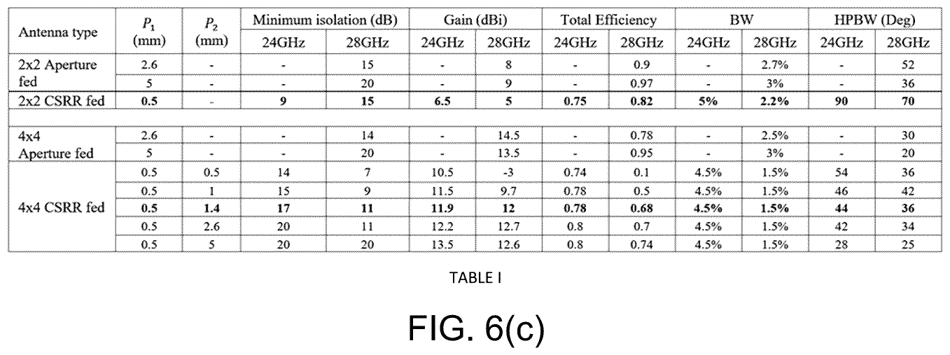

An exemplary CSRR fed 2×2 array design with diagonal CSRRs offers significantly smaller area compared to the conventional 2×2 array in the main frequency band and can also add more bands based on coupled resonances that happen among CSRRs, which means that two large antenna arrays can be turned into one compact array, as depicted in FIG. 5. To determine the size reduction, a comparison is made using HFSS simulations. As illustrated in FIGS. 6(a)-6(b), two different asymmetric power splitters are utilized for a 2×2 by either 90-degree (π/2) or 180-degree (π) phase differences corresponding to circular or linear radiation polarization for the 2×2 array. Such a simple power splitter is chosen to demonstrate the gain and polarization performance of the disclosed design. In transceiver arrays and radar applications, each patch element can be connected to its Tx/Rx circuit. Therefore, a constant phase difference is used along with appropriate phase shift algorithms for broadside beam-steering applications.

According to Table I (FIG. 6(c)), the isolation performance of the 2×2 CSRR-fed array with p=500 μm surpasses a 2×2 aperture-fed patch array with p=2.6 mm, (λ_{g}/2), showing an 80% reduction in array pitch which is equal to 45% array area reduction in the main frequency band of 28.5 GHz. For both arrays, the minimum isolation is below −15 dB at 28.5 GHz and below −10 dB at 24 GHz. This size reduction occurs at almost no cost in bandwidth and radiation efficiency, since at 28 GHz, only a 0.5% and a 0.8% drop are observed in the bandwidth and efficiency respectively.

On the other hand, the half power beam width (HPBW) of the miniaturized array at 28.5 GHz is 18 and 34 degrees wider than a conventional single band aperture fed antenna with 2.6 and 5 mm pitches respectively. This explains the lower value in the maximum simulated gain of this dual band antenna. The finite element simulation shows 5 dBi gain at 28 GHz compared to 8 dBi for aperture-fed array with half wavelength pitch. However, one main advantage of the disclosed array is its second frequency band with 5% bandwidth at 24 GHz, which is relatively wide compared to conventional aperture-fed patch arrays. At this frequency, the CSRR-fed array has 75% total efficiency, and the maximum realized gain is 6.5 dBi with a wide 90-degree HPBW on the broad side. It is noted that there is a trade-off between pitch reduction and antenna efficiency.

As illustrated in FIG. 5, larger arrays can be designed by tiling 2×2 sub arrays with a tile pitch p₂ to maintain desired isolation and avoid efficiency drop and shift in the resonant frequencies. It is also noted that a very large pitch will reduce the main lobe gain and add higher side lobes. In an exemplary design, the feeding points (CSRRs) are located close to the center of the 2×2 array which makes it easier to extend the array dimension using small tile pitch p₂ since the feeding CSRRs have the maximum distance to adjacent tiles.

Based on Table I (FIG. 6(c)), the isolation, radiation efficiency, and BW of the 4×4 array at 24 GHz is almost identical for p₂ ranging from 0.5 mm to 2.6 mm. These values do not change by scaling the array from 2×2 to 4×4, which means that this feeding technique provides high isolation at 24 GHz between adjacent tiles and eliminates the need for any decoupling structures between the tiles as used within the 2×2 array. However, the radiation efficiency at 28 GHz depends on the tile pitch p₂. In the ideal case of p₂=⁵ mm, the radiation efficiency of the 4×4 array is equal to that of the 2×2 aperture-fed array with p₂=5 mm, indicating that no loss is imposed by adding more antennas to the array.

To calculate the possible size reduction in the 4×4 array, a comparison can be made between a conventional aperture-fed array and the disclosed CSRR-fed array with tile configuration. Table I shows that the efficiency of the 4×4 CSRR-fed with p₁=0.5 mm and p₂=1.4 mm is equal to the efficiency of the 4×4 aperture-fed antenna with p₁=2.6 mm, which means a 50% size reduction in addition to an extra frequency band in the novel 4×4 CSRR-fed patch array without adding anymore bandgap structure. Therefore, the disclosed design combines two arrays into one compact array with total size reduction of 70% for both 2×2 and 4×4 arrays. This is based on the size of the disclosed antenna divided by the sum of two arrays at 24 GHz and 28 GHz.

In the mmWave frequency range, the surface smoothness of conductors, which can depend on the substrate surface, cannot be neglected. Surface roughness appears as a factor in signal attenuation constant and increases the signal loss. For a microstrip line at frequencies above 20 GHz, the roughness induced loss of the transmission line is significant. However, it is noted that this parameter is process-dependent and different packaging and assembly techniques offer different surface qualities. For example, high frequency Rogers PCBs do not offer surfaces smoother than 500 nm while epoxy resins or mold compounds and polyimide dielectrics and ceramics offer smoother surfaces.

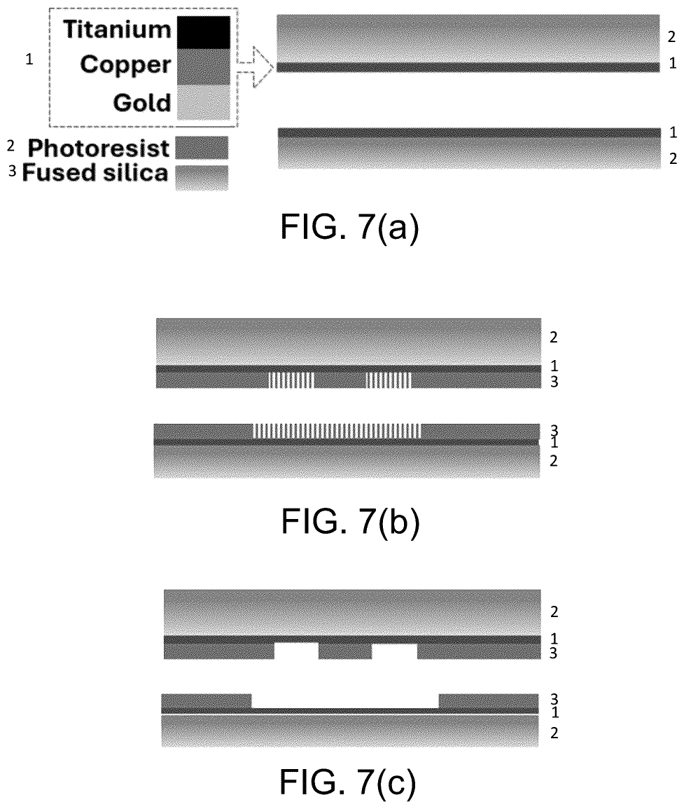

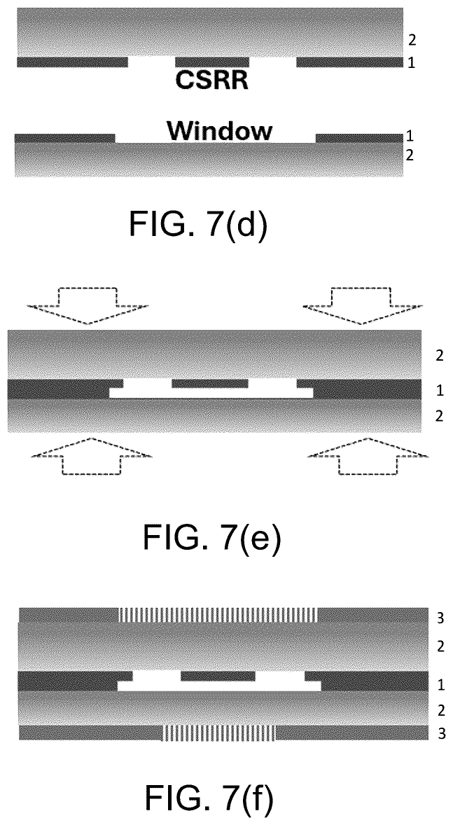

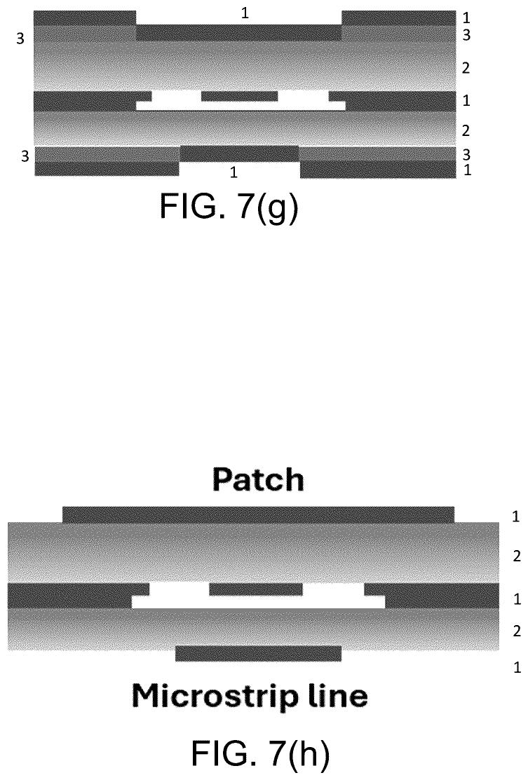

In accordance with various embodiments, the disclosed antenna array is fabricated on a double layer fused silica substrate with nanometer scale roughness. As shown in FIG. 7(a), four-inch wafers are used for top and bottom substrates with 350 μm and 180 μm thicknesses respectively. The two wafers are stacked up by Cu—Cu thermo-compression bonding technique using EVG501 wafer bonder machine. Hence before performing the bonding process, three metal layers are required for the ground plane and to also act as the bonding interface. First, a 30 nm layer of titanium is sputtered on one side of each wafer to increase the adhesion between fused silica and copper. This is followed by a layer of 1.5 μm thick copper and is finished by a 50 nm layer of gold as the passivation layer to prevent Cu oxidization and improve bonding strength. The total thickness of copper on the ground layer is then 3 μm to handle the skip effect at the target frequency.

In the next step (FIG. 7(b)), CSRRs are patterned by photolithography and then etched away from the sputtered ground plane on the top substrate. The photoresist is then exposed (FIG. 7(c)) and CSRRs and windows are etched (FIG. 7(d)) on the ground planes of the top and bottom substrate. Since there must be metal on both wafers and to also avoid misalignment effects on the CSRRs' resonant frequency, CSRRs are only created on the top wafer while the bottom wafer contains a slightly wider window instead (20 μm wider on width and length), as illustrated in FIG. 7(d), to avoid any short circuit caused by overlap.

Next, in FIG. 7(e), thermo-compression Bonding is performed under 3500N force and 400° C. temperature for 2:30 hours. In FIG. 7(f), antennas and feedlines are then patterned on the top and bottom surface of the bonded sample with negative photoresist. It is followed by sputtering Ti, Cu, and Au on both sides with 2 μm total thickness, as shown in FIG. 7(g). As the final step, in FIG. 7(h), the photoresist lift-off is performed simultaneously on both sides of the sample.

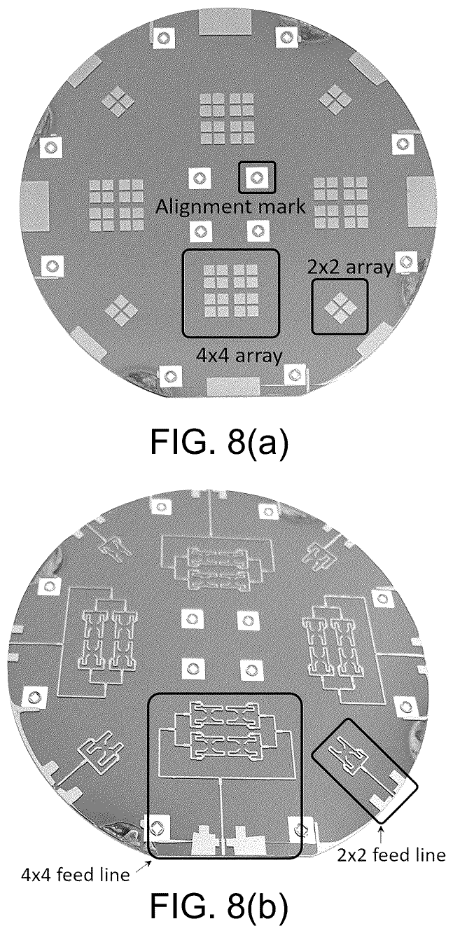

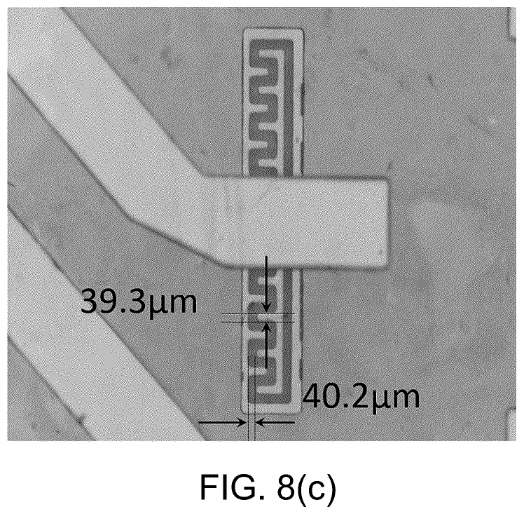

To demonstrate a fabricated example, FIGS. 8(a)-8(c) show a four-inch sample with multiple arrays fabricated on it, with FIG. 8(a) showing patch arrays made on the 350 μm thick wafer; FIG. 8(b) showing fabricated feedlines made on the 180 μm thick wafer; and FIG. 8(c) showing a CSRR inside its window made on the ground plane between the two wafers. The grey color belongs to the Ti layer which is the first layer of ground plane seen through fused silica on both sides. Thanks to the transparency of fused silica, the dimensions, and alignments of CSRRs can be investigated after the fabrication.

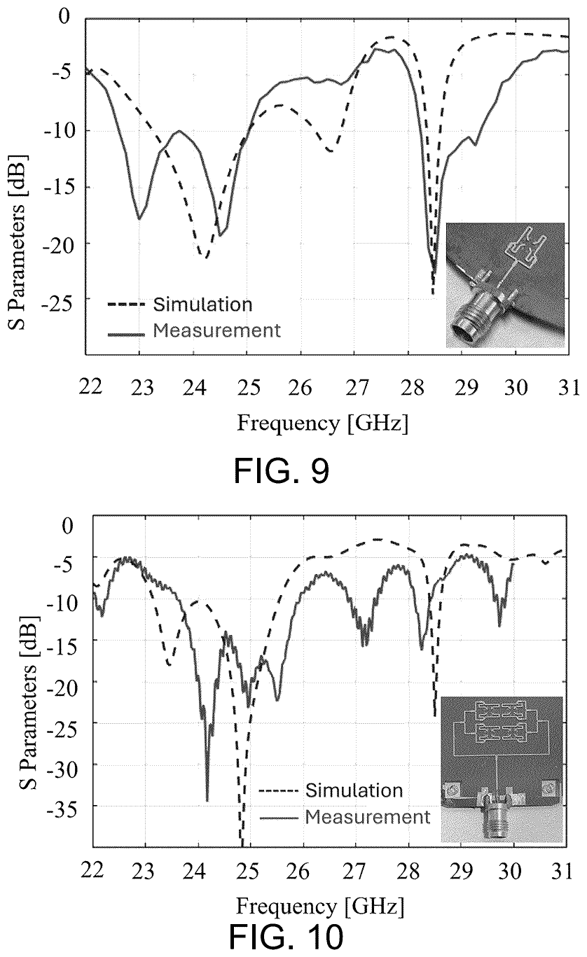

To compare the measured and simulated return loss of a connectorized 2×2 and 4×4 array respectively, a fabricated antenna arrays are connectorized with an edge mount 1.85 mm Amphenol PCB mount connector and measurements are performed utilizing E8361A Keysight power network analyzer. Accordingly, FIG. 9 and FIG. 10 compare the measured and simulated return loss of a connectorized 2×2 and 4×4 array respectively. These return loss graphs belong to 180° asymmetric design of FIG. 6(a). The slight discrepancy observed in both 2×2 and 4×4 arrays is contributed to the fabrication tolerance and misalignment. For example, while CSRR width a and gap b have been optimized to be 38 μm, one of the fabricated CSRRs shows a=39.3 μm and b=40.2 μm in FIG. 8(c), which can explain the lower measured frequency resonances for both 2×2 and 4×4 arrays. Since there are sixteen CSRRs and patches in a 4×4 array, the frequency response deviation can be significant if process tolerance is beyond acceptable errors.

On the other hand, due to possible mismatch between the connector and the feedline, small ripples in simulated return loss are magnified in the measurements, especially for the 4×4 array for which the measured 10 dB bandwidths are 2.8 GHz centered at 24.8 GHz and 325 MHz at 28.2 GHz. While a wider bandwidth is observed in the 2×2 array, the 4×4 array shows a slightly lower BW due to increased array dimension and more complicated feedline network with multiple microstrip power splitters between the input connector and each antenna element.

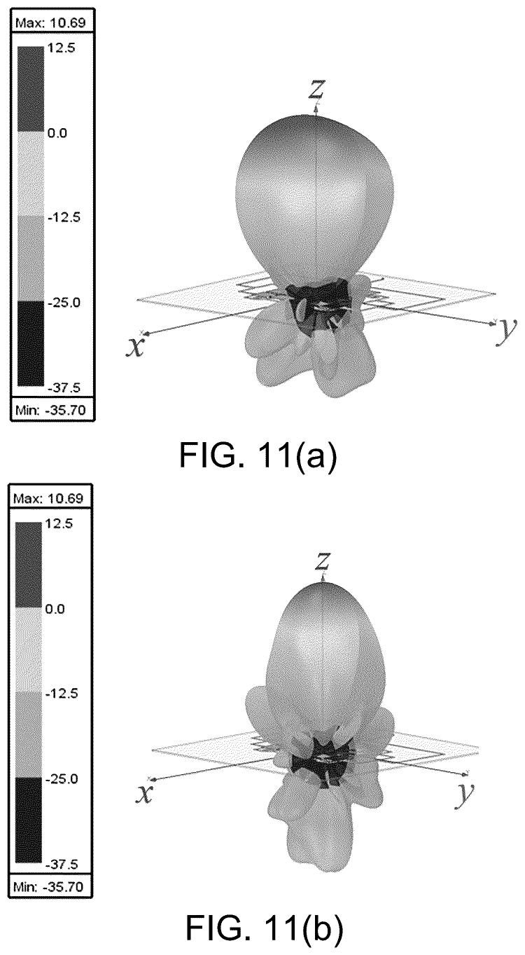

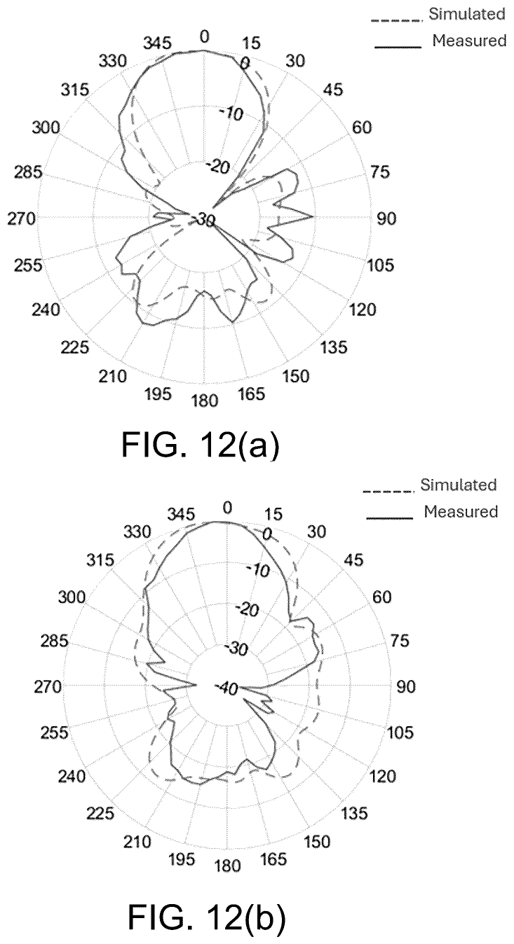

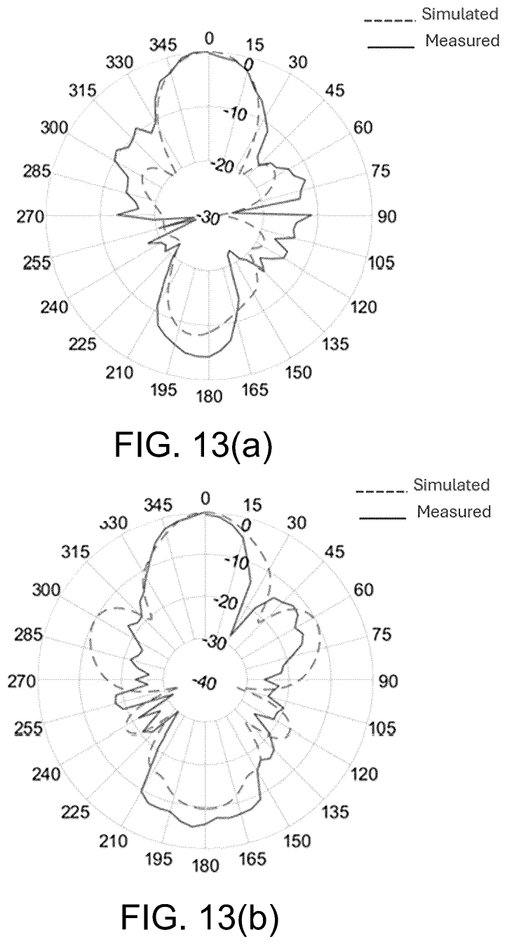

Radiation pattern measurements are performed for a 4×4 array in semi-anechoic conditions by surrounding the measurement setup using high-frequency absorbers to reduce the interference. To do so, two standard horn antennas working at 18-26.4 GHz and 26.5 GHz-40 GHz with 20 dBi gain are placed 25 cm away from the 4×4 array and radiation patterns are measured for center frequencies of the two operating bands. While FIGS. 11(a)-11(b) provide the anticipated three-dimensional radiation pattern obtained by simulations, FIGS. 12(a)-12(b) and 13(a)-13(b) compare normalized measured and simulated radiation patterns in E-plane and H-plane for both frequencies of interest. The measured radiation gain and pattern are in good agreement with the FEM (Finite Element Method) simulations specifically on the main lobe HPBW. However, there is a slight increase in the measured back lobe and side lobe levels which can be attributed to fabrication errors especially in the CSRRs' dimensions.

In summary, an exemplary antenna array is designed on an ultra-low loss and smooth surface roughness dual-layered fused silica substrate to simultaneously operate in both a 5G new radio (5G-NR) of 28 GHz and an IoT band of 24 GHz, for a frequency handover application. The antenna array operates based on coupled resonance theory, in which the resonant frequencies are the result of resonant coupling between closely located meanderline complementary split ring resonators (CSRRs) on the ground plane that also act as bandgap structures to maintain acceptable mutual decoupling among array elements. An exemplary antenna array's performance has been compared with single band aperture fed patch array in Table I (FIG. 6(c)), where an overall 70% size reduction is observed for a 2×2 array since it is not only compact but also works as two arrays working at 24.5 GHz and 28.5 GHz bands. As such, the present disclosure presents a novel compact dual-band patch antenna array that is based on coupled CSRR resonators on the ground plane which also act as bandgap structures to maintain acceptable mutual decoupling among array elements. As such, the fabricated antenna can work both at 24 GHz and 28 GHz to be utilized in frequency handover applications. In various embodiments, an exemplary CSRR-fed array is fabricated on dual layer fused silica substrate with ultra smooth surface and low dielectric loss. The return loss measurements for the fabricated array are shown to be in good agreement with finite element (FE) analysis with slight discrepancies attributed to fabrication tolerances.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A dual-band antenna array comprising:
a top layer of fused silica substrate;
a bottom layer of fused silica substrate;
a ground plane positioned between the top and bottom layers of fused silica substrate, wherein the ground plane comprises layers of three different metals;
antenna patch elements arranged on top of the top layer of fused silica substrate;
an input feedline arrange on the bottom layer of the fused silica substrate; and
a meanderline complimentary split ring resonator structure etched on a top surface of the ground plane, wherein the input feedline is directly coupled to the meanderline complimentary split ring resonator structure and is configured to excite a plurality of resonance frequencies of the antenna patch elements.

2. The dual-band antenna array of claim 1, wherein the plurality of resonant frequencies comprise 28 GHz and at 24 GHz.

3. The dual-band antenna array of claim 1, wherein the antenna patch elements comprise a 2×2 patch antenna array.

4. The dual-band antenna array of claim 3, wherein the top layer of fused silica substrate comprises a 350 μm thick fused silica wafer.

5. The dual-band antenna array of claim 4, wherein the bottom layer of fused silica substrate comprises a 180 μm thick fused silica wafer.

6. The dual-band antenna array of claim 5, wherein four patch elements of the 2×2 patch antenna array are separated by a pitch p=0.048λ₀ with λ₀ being a free space wavelength.

7. The dual-band antenna array of claim 6, wherein the three different metals comprise titanium, copper, and gold.

8. The dual-band antenna array of claim 1, wherein the input feedline comprises an asymmetric microstrip line attached to an open stub.

9. The dual-band antenna array of claim 1, wherein the input feedline comprises an asymmetric feedline.

10. The dual-band antenna array of claim 1, wherein the meanderline complimentary split ring resonator structure comprises four meanderline complimentary split ring resonators that are configured to resonate around a desired frequency and are placed diagonally on the ground plane beneath the antenna patch elements.

11. The dual-band antenna array of claim 1, wherein the antenna patch elements comprise a 4×4 patch antenna array.

12. A method fabricating a dual-band antenna array comprising:
providing a top layer of fused silica substrate and a bottom layer of fused silica substrate;
forming a ground plane between the top and bottom layers of the fused silica substrate by depositing a titanium metal layer on one side of each of the top layer and the bottom layer of the fused silica substrate, depositing a copper metal layer on top of the titanium metal layer on each of the top layer and the bottom layer of the fused silica substrate, and depositing a gold metal layer on top of the copper metal layer on each of the top layer and the bottom layer of the fused silica substrate;
etching meanderline complimentary split ring resonators on a top surface of the ground plane;
bonding the top layer of fused silica substrate and ground plane with the bottom layer of fused silica substrate and ground plane; and
patterning antenna elements and a microstrip feedline on a top and bottom surface of the bonded fused silica substrate and ground plane, wherein the microstrip feedline is directly coupled with the meanderline complimentary split ring resonators and excites a plurality of resonant frequencies of the antenna elements.

13. The method of claim 12, wherein the plurality of resonant frequencies comprise 28 GHz and at 24 GHz.

14. The method of claim 12, wherein the titanium metal layer comprises a 30 nm thick titanium metal layer, the copper metal layer comprises a 1.5 μm thick copper metal layer, and the gold metal layer comprises a 50 nm thick gold metal layer.

15. The method of claim 12, wherein the antenna elements comprise a 2×2 patch antenna array.

16. The method of claim 12, wherein the top layer of fused silica substrate comprises a 350 μm thick fused silica wafer.

17. The method of claim 16, wherein the bottom layer of fused silica substrate comprises a 180 μm thick fused silica wafer.

18. The method of claim 12, wherein the microstrip feedline comprises an asymmetric microstrip line attached to an open stub.

19. The method of claim 12, wherein the meanderline complimentary split ring resonators comprise four meanderline complimentary split ring resonators that are configured to resonate around a desired frequency and are placed diagonally on the ground plane beneath the antenna elements.

20. The method of claim 12, wherein the antenna elements comprise a 4×4 patch antenna array.
